(19) United States
(12) Patent Application Publication
(10) Pub. No.: US 2026/0087151 A1
(43) Pub. Date: Mar. 26, 2026

(54) INFORMATION PROCESSING APPARATUS AND METHOD, AND PROGRAM

(71) Applicant: Sony Semiconductor Solutions Corporation, Kanagawa (JP)

(72) Inventor: Munetake EBIHARA, Kanagawa (JP)

(73) Assignee: Sony Semiconductor Solutions Corporation, Kanagawa (JP)

(21) Appl. No.: 19/110,824

(22) PCT Filed: Sep. 6, 2023
(86) PCT No.: PCT/JP2023/032462

§ 371 Date: Mar. 12, 2025

(30) Foreign Application Priority Data
Sep. 21, 2022 (JP) 2022-150568

(51) Int. Cl. G06F 21/60; G06F 21/64

(52) U.S. Cl. CPC G06F 21/602; G06F 21/64

(57) ABSTRACT

The present technique relates to an information processing apparatus, an information processing method, and a program that enable a contextual relationship of data to be proved even when troubleshooting of equipment has been carried out.

The information processing apparatus is an information processing apparatus that generates output data including object data to be a verification object of a temporal contextual relationship, the information processing apparatus including: a control unit configured to generate the output data including a hash value calculated on the basis of a part of or all of output data that temporally immediately-precedes the output data, the object data, and a plurality of mutually-different types of ID information related to the object data. The present technique can be applied to cameras.

### TECHNICAL FIELD

The present technique relates to an information processing apparatus, an information processing method, and a program and, particularly, to an information processing apparatus, an information processing method, and a program that enable a contextual relationship of data to be proved even when troubleshooting of equipment has been carried out.

### BACKGROUND ART

Conventionally, in order to prove a provenance of an image such as a photograph in terms of which piece of equipment was used to take the image at what time of day, there are demands to prove the photographic equipment used to take the image and continuity of the image or, in other words, a contextual relationship of a plurality of images even if the images were taken offline.

In relation to such demands, attempts to manage a provenance and an editorial history of digital content such as C2PA (The Coalition for Content Provenance and Authenticity) are also known.

In addition, for example, as a technique to guarantee a continuity of video images, a technique has been proposed to generate and record a hash value related to a group of time-series data each time latest data is input to a dashboard camera that sequentially erases older video images (for example, refer to PTL 1).

### CITATION LIST

### Patent Literature

### PTL 1

JP 2011-180784A

### SUMMARY

### Technical Problem

However, the technique described above does not take into account a replacement of an image sensor or a replacement of photographic equipment such as a camera due to a malfunction or other reasons.

Therefore, when troubleshooting of equipment is carried out such as a replacement of an image sensor or a camera, it is sometimes impossible to prove a contextual relationship of a plurality of images (data) before and after the troubleshooting such as images before and after the replacement of the image sensor.

The present technique has been devised in consideration of the situation described above and an object thereof is to enable a contextual relationship of data to be proved even when troubleshooting of equipment is carried out.

### Solution to Problem

An information processing apparatus according to a first aspect of the present technique is an information processing apparatus that generates output data including object data to be a verification object of a temporal contextual relationship, the information processing apparatus including: a control unit configured to generate the output data including a hash value calculated on the basis of a part of or all of output data that temporally immediately-precedes the output data, the object data, and a plurality of mutually-different types of ID information related to the object data.

An information processing method or a program according to the first aspect of the present technique is an information processing method or a program of an information processing apparatus that generates output data including object data to be a verification object of a temporal contextual relationship, the information processing method or a program including the step of: generating the output data including a hash value calculated on the basis of a part of or all of output data that temporally immediately-precedes the output data, the object data, and a plurality of mutually-different types of ID information related to the object data.

In the first aspect of the present technique, in the information processing apparatus that generates output data including object data to be a verification object of a temporal contextual relationship, the output data including a hash value calculated on the basis of a part of or all of output data that temporally immediately-precedes the output data, the object data, and a plurality of mutually-different types of ID information related to the object data is generated.

An information processing apparatus according to a second aspect of the present technique is an information processing apparatus that verifies a temporal contextual relationship between object data included in output data and another object data included in another output data, the output data including a hash value calculated on the basis of a part of or all of output data that temporally immediately-precedes the output data, the object data, and a plurality of mutually-different types of ID information related to the object data, the information processing apparatus including a control unit configured to verify a temporal contextual relationship between the object data and the other object data by comparing the hash value calculated on the basis of a part of or all of one of the output data and the other output data and the hash value included in the other of the output data and the other output data and by comparing the pluralities of types of ID information respectively included in the output data and the other output data.

An information processing method or a program according to the second aspect of the present technique is an information processing method or a program of an information processing apparatus that verifies a temporal contextual relationship between object data included in output data and another object data included in another output data, the output data including a hash value calculated on the basis of a part of or all of output data that temporally immediately-precedes the output data, the object data, and a plurality of mutually-different types of ID information related to the object data, the information processing method or a program including the step of verifying a temporal contextual relationship between the object data and the other object data by comparing the hash value calculated on the basis of a part of or all of one of the output data and the other output data and the hash value included in the other of the output data and the other output data and by comparing the pluralities of types of ID information respectively included in the output data and the other output data.

In the second aspect of the present technique, in an information processing apparatus that verifies a temporal contextual relationship between object data included in output data and another object data included in another output data, a temporal contextual relationship between the object data and the other object data is verified by comparing a hash value calculated on the basis of a part of or all of one of the output data and the other output data and the hash value included in the other of the output data and the other output data and by comparing the pluralities of types of ID information respectively included in the output data and the other output data. In addition, the output data includes a hash value calculated on the basis of a part of or all of output data that temporally immediately-precedes the output data, the object data, and a plurality of mutually-different types of ID information related to the object data.

### BRIEF DESCRIPTION OF DRAWINGS

FIG. 1 is a diagram showing a configuration example of a photographing apparatus.

FIG. 2 is a diagram showing a configuration example of a smartphone.

FIG. 3 is a diagram showing an example of temporally consecutive pieces of output data.

FIG. 4 is a flow chart for explaining photography processing.

FIG. 5 is a flow chart for explaining image data generation processing.

FIG. 6 is a diagram showing a configuration example of an information processing apparatus.

FIG. 7 is a flow chart for explaining verification processing.

FIG. 8 is a diagram showing a configuration example of a computer.

### DESCRIPTION OF EMBODIMENTS

Hereinafter, embodiments to which the present technique is applied will be described with reference to drawings.

### First Embodiment

### Present Technique

The present technique enables a contextual relationship of data to be proved even when troubleshooting of equipment is carried out by utilizing a plurality of mutually-different types of ID information and a distributed time-stamping technique.

The distributed time-stamping technique refers to a technique that makes it possible to trace, in a plurality of pieces of data in a time series, a time series (contextual relationship) of all of the pieces of data by repeatedly creating nested data chains in which new data is embedded with a hash value of temporally-preceding data.

In the present technique, with respect to object data to be a verification object of a temporal contextual relationship, data (hereinafter, also referred to as output data) including the object data or ID information related to the object data is generated.

In this case, the object data to be a verification object of a contextual relationship (continuity) or, in other words, authenticity can be original data such as a RAW image obtained by photography. Other object data may be any kind of data such as an image obtained by performing development processing on original data or an image obtained by performing editing processing on any image or, in other words, processing data (processed data) obtained by performing any kind of processing.

In particular, the original data to be used as object data is not limited to an image obtained by photography and can be any data generated by some kind of method such as an output image of a simulator that has technical characteristics of an image sensor (simulator output image).

For example, when an output image of a simulator is to be used as object data, output data proving that the output image is an output series of a specific simulator is to be generated.

The output data includes a plurality of mutually-different types of ID information related to the object data.

The ID information is, for example, ID information that identifies hardware in sensor hardware such as an image sensor or an image processor provided in a camera as photographic equipment. In addition, the output data may store ID information that identifies a processor referred to as an SoC (System-on-a-Chip), an application processor, or the like for a predetermined application provided in a stage subsequent to the sensor hardware, ID information for identifying a storage such as a removable storage medium that can be attached to or detached from the photographic equipment, and the like.

In addition, a user ID of an account of a user having generated the object data being used in any service related to the object data such as cloud computing or editing may be stored in the output data as ID information related to the object data.

Furthermore, in addition to the object data and ID information, the output data also includes a hash value calculated on the basis of a part of or all of output data generated temporally preceding (immediately preceding) the output data and the hash value functions as a distributed time stamp. In this case, at least ID information included in the output data is used to calculate the hash value.

For example, there is a known technique to store a time of day (time stamp) supplied by a time-stamping service in image data (image file) to prove a contextual relationship of an image. However, this technique requires that a connection to the time-stamping service (an online state) be established when the image data is being generated.

By contrast, in the present technique, a hash value that functions as a distributed time stamp is stored in output data.

Since the hash value can be generated without having to connect to an external apparatus (service), output data of a time series that can prove a contextual relationship of object data can be obtained even in an offline environment.

Accordingly, even when output data is generated in an offline environment, a relationship between pieces of output data (object data) that precede and follow each other in a time series or a contextual relationship with an online time stamp when output data is published or, in other words, a contextual relationship with published output data can be proved.

Therefore, by utilizing a contextual relationship in a time series of output data (object data), it is possible to prove a provenance of the object data or prove that the object data has not been tampered with. In other words, object data generated (photographed) using one's own equipment or object data only subjected to simple editing can be distinguished from other data.

Furthermore, since ID information is used to calculate the hash value and the output data contains a plurality of types of ID information, even when troubleshooting of equipment is carried out when generating output data of a time series, the plurality of types of ID information can be used to prove the contextual relationship of the object data.

For example, using the hash value in the output data enables a contextual relationship between two pieces of temporally consecutive object data to be specified.

However, for example, if two pieces of output data that temporally precede and follow each other respectively include a sensor ID that identifies an image sensor as ID information but the sensor IDs differ from each other, it cannot be said that the contextual relationship between the two pieces of output data or, in other words, two prices of object data is proven. The reason for this is that, since the sensor IDs of the two pieces of object data do not match, it cannot be said that provenances of the two pieces of object data are the same.

Such a mismatch between sensor IDs can occur when an image sensor of photographic equipment is replaced due to, for example, a failure of the image sensor.

By contrast, in the present technique, output data stores a plurality of types of ID information. Therefore, for example, even if one type of ID information such as a sensor ID does not match with respect to two pieces of object data, if another type of ID information such as a user ID matches, the provenance of the two pieces of object data can be specified to be the same. In other words, the contextual relationship of the two pieces of object data can be proved.

In addition, by enabling the contextual relationship of object data (output data) to be proved using a hash value that functions as a distributed time stamp, the number of communications or a time of communication with external apparatuses can be reduced and communication costs can also be lowered.

### Configuration Example of Photographing Apparatus

The present technique as described above can be applied to various devices (information processing apparatuses) including photographic equipment such as a camera, a smartphone or a tablet with a photographic function, and a personal computer that enables images to be edited and function as a simulator that generates images.

Hereinafter, a case where image data is generated as the output data described above by a device with a photographic function will be described as a specific example.

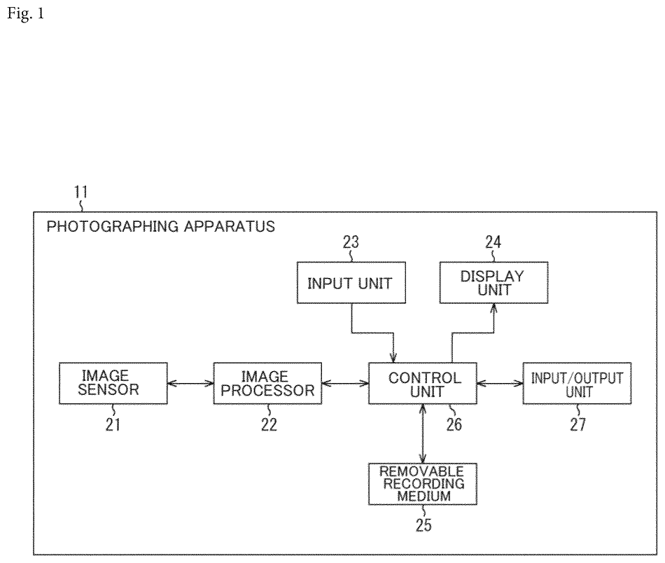

FIG. 1 is a diagram showing a configuration example of an embodiment of a photographing apparatus to which the present technique has been applied.

A photographing apparatus 11 is constituted of a camera or the like and generates an image as the object data described above and also generates image data including the image (data of the image) as the output data described above.

The photographing apparatus 11 includes an image sensor 21, an image processor 22, an input unit 23, a display unit 24, a removable recording medium 25, a control unit 26, and an input/output unit 27.

The image sensor 21 receives and photoelectrically converts light incident from a surrounding subject through an optical system (not illustrated) to photograph the surrounding subject and supplies the image processor with a resulting RAW image or, more specifically, image data of the RAW image. In other words, the image sensor 21 functions as a photographing unit that photographs a RAW image.

While a plurality of temporally consecutive RAW images are photographed by the image sensor 21, each RAW image may be a still image or a single frame constituting a moving image (video) or, in other words, an image corresponding to a single frame.

In addition, the image sensor 21 holds a sensor ID that is, for example, ID information uniquely identifying the image sensor 21 itself and supplies the image processor 22 with the sensor ID when necessary.

The image processor 22 is constituted of, for example, a processor called an ISP (Image Signal Processor) or the like and holds an ISP ID or, in other words, a processor ID that is ID information uniquely identifying the image processor 22 itself.

The image processor 22 generates, based on a RAW image supplied from the image sensor 21, image data including the RAW image by performing predetermined image processing or the like and supplies the control unit 26 with the image data.

Note that, hereinafter, image data that is generated by the image processor 22 and includes a RAW image may also be particularly referred to as output RAW image data. A RAW image and output RAW image data correspond to the object data and the output data described above.

For example, in addition to a RAW image or, more specifically, image data of the RAW image, output RAW image data includes metadata of the RAW image and the like.

For example, the metadata of a RAW image includes a reduced image (thumbnail image) of the RAW image having been generated from the RAW image, ID information related to photography of the RAW image, a hash value calculated with respect to temporally preceding (immediately preceding) output RAW image data, and the like.

The hash value included in the metadata is calculated on the basis of all of preceding output RAW image data or data constituting a part of the preceding output RAW image data that is the metadata or the like.

In addition, the metadata of the RAW image includes at least any of, for example, a sensor ID of the image sensor 21 and an ISP ID of the image processor 22 as ID information.

In this case, by storing the sensor ID of the image sensor 21 in the metadata, even when the image sensor 21 is replaced during troubleshooting or, in other words, a repair to the photographing apparatus 11, the image sensor 21 can be tracked (specified) before and after the replacement using the sensor ID.

Furthermore, the image sensor 21 and the image processor 22 may be provided on the same single chip or the image sensor 21 and the image processor 22 may be provided on mutually-different chips.

For example, when output RAW image data is generated by the image processor 22 in a stage subsequent to the image sensor 21, there is a risk of tampering of a RAW image on a communication channel between the image sensor 21 and the image processor 22 (hardware communication channel).

In consideration thereof, for example, by providing the image sensor 21 and the image processor 22 on the same chip, the image processor 22 may be arranged in a vicinity of the image sensor 21 to suppress an occurrence of tampering.

In addition, by having the image sensor 21 and the image processor 22 mutually authenticate each other and exchange data such as RAW images through encrypted communication, an authenticated communication channel can be constructed to suppress an occurrence of tampering. Otherwise, output RAW image data may be generated by the image sensor 21.

The input unit 23 is constituted of various buttons or switches, a touch panel provided so as to be superimposed on the display unit 24, or the like and supplies the control unit 26 with a signal in accordance with an operation by a user.

The display unit 24 is constituted of a small display or the like and displays various types of images including an image photographed by the photographing apparatus 11 and a menu image in accordance with control by the control unit 26.

The removable recording medium 25 is, for example, a storage that is attachable to and detachable from the photographing apparatus 11 and records various types of data including data such as an image supplied from the control unit 26, and supplies the control unit 26 with recorded data when necessary.

In addition, the removable recording medium 25 also records, for example, a medium ID that is ID information uniquely identifying the removable recording medium 25 itself.

The control unit 26 is constituted of, for example, a processor called an SoC, an application processor, or the like and controls operations of the entire photographing apparatus 11 in accordance with a signal supplied from the input unit 23.

For example, the control unit 26 performs various types of image processing such as development processing with respect to a RAW image based on output RAW image data supplied from the image processor 22 and generates a JPEG (Joint Photographic Experts Group) image.

A JPEG image is a reversibly compressed image in the JPEG format that is obtained by, for example, subjecting a RAW image to development processing. While a case where a system of compression processing during development processing is the JPEG system will be described as an example, the system of compression processing may be any other system.

In addition, for example, the control unit 26 generates a JPEG image or, more specifically, image data of a JPEG image as the object data described above and generates image data containing the JPEG image as the output data described above.

Note that, hereinafter, image data as output data including a JPEG image that is generated by the control unit 26 will also be particularly referred to as output JPEG image data.

For example, in addition to a JPEG image, the output JPEG image data includes the metadata of a RAW image included in the output RAW image data having been used when generating the output JPEG image data, ID information related to generation or the like of the JPEG image, a hash value calculated with respect to temporally preceding (immediately preceding) output JPEG image data, or the like.

In this case, the ID information included in the output JPEG image data can be, for example, a medium ID of the removable recording medium 25 in which the output RAW image data used to generate a JPEG image had been recorded or to be used as a recording destination of the generated output JPEG image data.

In addition, for example, there may be cases where a user ID of some kind of an account of a user of the photographing apparatus 11 can be acquired by communication performed by the photographing apparatus 11 with an external apparatus using a communicating unit (not illustrated) or the like. In such a case, the user ID may be included in the output JPEG image data in place of, or together with, the medium ID. Other ID information such as a camera ID that identifies the photographing apparatus 11 may also be used as the ID information.

Furthermore, the hash value that is included in the output JPEG image data and that is related to output JPEG image data temporally preceding the output JPEG image data is calculated on the basis of all of the preceding output JPEG image data or data constituting a part of the preceding output JPEG image data. In this case, for example, ID information such as a medium ID or a user ID included in the output JPEG image data is to be used to calculate the hash value.

For example, the input/output unit 27 is constituted of an input/output interface or the like and outputs any data such as output JPEG image data supplied from the control unit 26 to an external apparatus connected to the photographing apparatus 11 in a wired manner or supplies the control unit 26 with data supplied from the external apparatus.

In the photographing apparatus 11 configured as described above, output RAW image data or output JPEG image data as output data of a time series stores a hash value obtained from temporally preceding output RAW image data or temporally preceding output JPEG image data.

Therefore, the hash value included in output data can be caused to function as a distributed time stamp and, accordingly, pieces of output data arranged in a time series can be chained in chronological order by the hash value. Moreover, the mechanism of chaining pieces of output data in this manner can be realized even when the photographing apparatus 11 is offline.

While an example in which output RAW image data or output JPEG image data as output data stores a hash value of preceding output data will be described herein, a signature obtained by encrypting the hash value may be used instead of the hash value.

In such a case, for example, ID information identifying the photographing apparatus 11 and a private key and a public key to constitute a pair in public-key cryptography are to be assigned when manufacturing the photographing apparatus 11.

In addition, when generating output data, a hash value of preceding output data is encrypted by the private key and a signature is generated. In other words, the hash value is signed by the private key. A signature obtained in this manner is stored in the output data. In addition, the signature is to be verified by the public key of the photographing apparatus 11 when verifying a contextual relationship of output data (object data).

For example, when output JPEG image data is generated as output data, the output JPEG image data is to include a JPEG image, metadata of a RAW image, ID information related to the generation of the JPEG image or the like, and a signature generated from preceding output JPEG image data.

Even when a signature is used in this manner, the signature can be caused to function as a distributed time stamp and pieces of output data can be chained in chronological order even in an offline environment.

When a signature is to be stored in output data instead of a hash value, data including the hash value may be signed. In addition, for example, ID information (camera ID) for identifying the photographing apparatus 11 may be used to generate a signature or stored in the output data.

Furthermore, either one of output RAW image data and output JPEG image data as output data may store a hash value and the other of output RAW image data and output JPEG image data may store a signature instead of a hash value, or both of the output RAW image data and the output JPEG image data may store a signature.

### Configuration Example of Smartphone

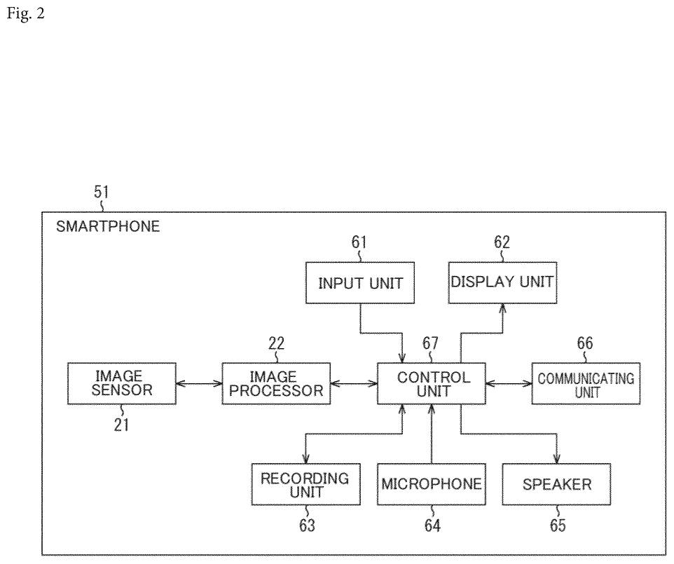

FIG. 2 shows a configuration example of a smartphone that has a photographic function and that generates output data. In FIG. 2, portions corresponding to FIG. 1 are denoted by same reference signs and descriptions of such portions will be omitted when appropriate.

A smartphone 51 shown in FIG. 2 has a photographic function and a calling function and generates output RAW image data or output JPEG image data as the output data described above.

The smartphone 51 includes the image sensor 21, the image processor 22, an input unit 61, a display unit 62, a recording unit 63, a microphone 64, a speaker 65, a communicating unit 66, and a control unit 67.

Even in the smartphone 51, output RAW image data is generated as output data by the image processor 22 or the image sensor 21 and the output RAW image data is supplied from the image processor 22 to the control unit 67 in a similar manner to the photographing apparatus 11.

For example, the input unit 61 is constituted of buttons or switches, a touch panel provided so as to be superimposed on the display unit 62, or the like and supplies the control unit 67 with a signal in accordance with an operation by a user.

The display unit 62 is constituted of a small display or the like and displays various types of images in accordance with control by the control unit 67.

The recording unit 63 is constituted of, for example, a memory and records various types of data such as an image supplied from the control unit 67 and also supplies the control unit 67 with recorded data when necessary.

The microphone 64 collects ambient sound such as the user's voice and supplies resulting voice data to the control unit 67. The speaker 65 outputs a voice based on the voice data supplied from the control unit 67.

The communicating unit 66 communicates with an external apparatus connected in a wireless manner. For example, the communicating unit 66 receives data transmitted from the external apparatus and supplies the control unit 67 with the received data or transmits data supplied from the control unit 67 to the external apparatus by wireless communication.

The control unit 67 is constituted of, for example, a processor called an SoC, an application processor, or the like and controls operations of the entire smartphone 51 in accordance with a signal supplied from the input unit 61.

For example, the control unit 67 performs various types of image processing such as development processing with respect to a RAW image based on output RAW image data supplied from the image processor 22 and generates output JPEG image data as the output data described above.

In addition, for example, the control unit 67 supplies voice data from a calling party supplied from the communicating unit 66 to the speaker 65 to play (output) a voice and also supplies the communicating unit 66 with voice data of the user's voice supplied from the microphone 64 and causes the communicating unit 66 to transmit the user's voice to the calling party.

In the photographing apparatus 11 and the smartphone 51 configured as described above, output RAW image data and output JPEG image data are generated as output data.

For example, generally, when one desires to prove a contextual relationship of images in a time series obtained by photography with a time stamp provided by a time-stamping service, it is necessary to connect to the server or the like of the time-stamping service at the time of photography. In other words, photography must be performed in an online state.

By contrast, in the present technique, in a device being the photographing apparatus 11 or the smartphone 51 itself that generates output data (object data) even in an offline state, a hash value that enables a contextual relationship to be proved using a distributed time-stamping technique is generated and stored in the output data.

Therefore, an amount of time spent online during photography can be reduced and a contextual relationship of a time series can be proved even with respect to object data generated in an offline environment.

For example, even with a device dedicated to a specific function such as a camera in which a communication function is not a primary function, a hash value can be used to prove a contextual relationship of images photographed in an offline environment such as outdoors.

In addition, in the present technique, with respect to attempts to manage a provenance and an editorial history of object data such as C2PA, the object data can be shown to be closer to original data.

For example, in the photographing apparatus 11 and the smartphone 51, a reduced image and a hash value (signature) are generated at a timing before an image is edited by an editing application. In other words, the output data using a distributed time-stamping technique is generated in a stage of processing by the image sensor 21 and the image processor 22 which is a timing immediately following photography.

Therefore, by using such output data generated in the stage immediately following photography, it is possible to show a likelihood that a RAW image or a JPEG image as the object data had been actually photographed. In other words, an image can be proved to be object data that is closer to original data.

Depending on a processing capability or the like of the image sensor 21, it may be difficult for the image sensor 21 to generate a hash value or a signature with an entire RAW image as an object.

In consideration thereof, for example, the photographing apparatus 11 and the smartphone 51 can generate a reduced image with the image processor 22 in a stage subsequent to the image sensor 21 and generate a hash value or a signature with the reduced image as an object.

Consequently, a processing load on the image sensor 21 can be reduced and resources of the image sensor 21 can be allocated to other processing such as achieving real-time image detection and reducing noise in analog circuits.

Moreover, by performing mutual authentication between the image sensor 21 and the image processor 22 that are connected to each other to construct an authenticated communication channel (encrypted communication channel) and exchanging encrypted RAW images over the communication channel, falsification of RAW images can be suppressed.

In addition, professionals who handle photographic equipment including a photographer who uses the photographic equipment or a contractor who repairs the photographic equipment may carry out troubleshooting of the equipment by replacing the image sensor 21 or replacing the photographing apparatus 11 itself as the photographic equipment. In such a case, a contextual relationship of object data (output data) may not always be provable as described above.

However, in the present technique, in addition to ID information of hardware such as the image sensor 21 and the image processor 22 included in equipment such as the photographing apparatus 11, a medium ID of the removable recording medium 25, a user ID of a user's online account, and the like are to be stored in output data.

Therefore, even when troubleshooting is carried out, the contextual relationship of object data can be proved by verifying that hash values match and, at the same time, one or more types of ID information among a plurality of types of ID information match. Furthermore, in the present technique, the contextual relationship of object data can be proved even when output data is generated in an offline state before online synchronization.

Specifically, for example, let us assume that a photographer performs photography with the photographing apparatus 11, output JPEG image data as output data is generated in response to the photography, and a sensor ID and a medium ID of the removable recording medium 25 are stored in the output JPEG image data.

Let us also assume that, in this case, due to an occurrence of a failure of the photographing apparatus 11, the photographer mounts the removable recording medium 25 having been mounted until then to the failed photographing apparatus 11 to another photographing apparatus 11 being a substitute apparatus, and continues photography using the other photographing apparatus 11.

In this case, last output data generated by the original photographing apparatus 11 and first output data generated by the other photographing apparatus 11 are to be consecutive (preceding and following) pieces of output data in a time series.

Now, let us assume that the first output data generated by the other photographing apparatus 11 stores a hash value of the last output data generated by the original photographing apparatus 11.

Since the two pieces of output data store different sensor IDs but store the same medium ID, the contextual relationship of the two pieces of output data can be proved from the hash value and the medium ID.

### Specific Example of Output Data

A specific example of output data in a time series or, in other words, pieces of temporally consecutive output data (object data) will now be described.

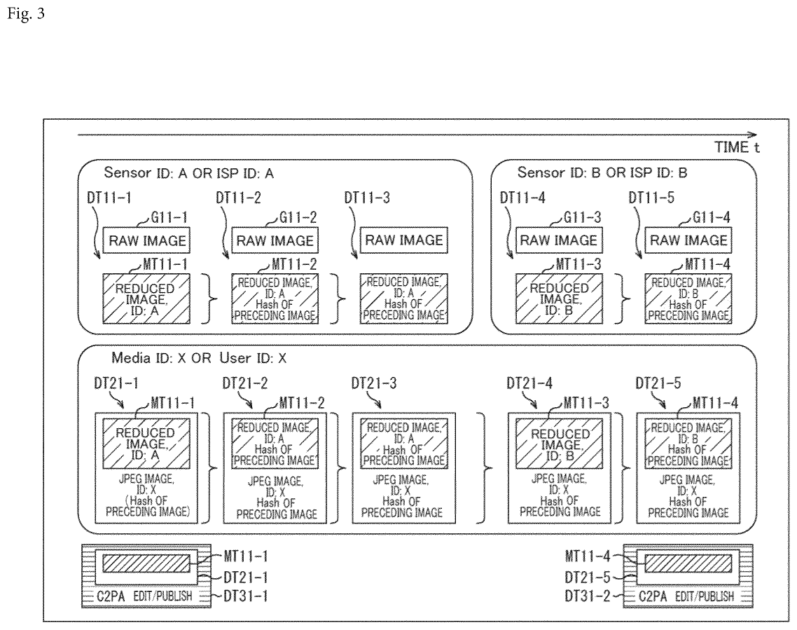

A case where output RAW image data and output JPEG image data are generated as output data will be described as an example with reference to FIG. 3. In FIG. 3, a horizontal direction indicates time.

In this example, for example, in the image processor 22 of the photographing apparatus 11, output RAW image data DT11-1 to output RAW image data DT11-3 are sequentially generated as output data.

The output RAW image data DT11-1 generated first includes a RAW image G11-1 obtained by photography by the image sensor 21 and metadata MT11-1 of the RAW image G11-1.

For example, based on the RAW image G11-1, the image processor 22 generates a reduced image (thumbnail) of the RAW image G11-1 and generates the metadata MT11-1 including the obtained reduced image and ID information “A”.

In this case, the ID information “A” stored in the metadata MT11-1 may be a sensor ID “A” indicating the image sensor 21 or an ISP ID “A” indicating the image processor 22. In addition, since the RAW image G11-1 is an image photographed first and a RAW image that temporally precedes the RAW image G11-1 does not exist, the metadata MT11-1 does not include a hash value of temporally-preceding output RAW image data.

In addition, the output RAW image data DT11-2 following the output RAW image data DT11-1 includes a RAW image G11-2 and metadata MT11-2 of the RAW image G11-2.

The metadata MT11-2 includes a reduced image of the RAW image G11-2, the ID information “A”, and a hash value with respect to the temporally preceding output RAW image data DT11-1.

The hash value with respect to the output RAW image data DT11-1 is, for example, a hash value of the metadata MT11-1 in the output RAW image data DT11-1 having been calculated by an operation of a hash function with the entire metadata MT11-1 as an object.

Alternatively, the hash value with respect to the output RAW image data DT11-1 may be a hash value having been calculated with the output RAW image data DT11-1 itself (entirety) as an object.

Otherwise, instead of a hash value, a signature generated on the basis of the hash value of metadata MT11-1 and a private key of the photographing apparatus 11 may be stored in metadata MT11-2.

The output RAW image data DT11-3 following the output RAW image data DT11-2 is also generated in a similar manner to the output RAW image data DT11-2.

In this example, after the output RAW image data DT11-1 to the output RAW image data DT11-3 as output data are recorded in the removable recording medium 25, a failure has occurred in the photographing apparatus 11.

Therefore, the user being the photographer continues photography using another photographing apparatus 11. In doing so, the user continues photography by mounting the removable recording medium 25 having been mounted until then to the original photographing apparatus 11 to the other photographing apparatus 11.

In this example, output RAW image data D11-4 and output RAW image data DT11-5 are newly generated by the continued photography and recorded in the removable recording medium 25.

The output RAW image data DT11-4 generated first includes a RAW image G11-3 and metadata MT11-3 of the RAW image G11-3, and the metadata MT11-3 stores a reduced image of the RAW image G11-3 and ID information “B”. The metadata MT11-3 does not include a hash value of preceding output RAW image data in a similar manner to the case of the output RAW image data DT11-1.

In this case, the ID information “B” is a sensor ID “B” indicating the image sensor 21 or an ISP ID “B” indicating the image processor 22 of the other photographing apparatus 11 used to perform photography.

The output RAW image data DT11-5 following the output RAW image data DT11-4 includes a RAW image G11-4 and metadata MT11-4 of the RAW image G11-4.

The metadata MT11-4 includes a reduced image of the RAW image G11-4, the ID information “B”, and a hash value of the metadata MT11-3 of the temporally preceding output RAW image data DT11-4.

With respect to the output RAW image data DT11-1 to the output RAW image data DT11-5 obtained in this manner, a contextual relationship of the output RAW image data DT11-1 to the output RAW image data DT11-3 and a contextual relationship of the output RAW image data DT11-4 and the output RAW image data DT11-5 can be proved.

In addition, in this example, in the other photographing apparatus 11 (hereinafter, also simply referred to as the photographing apparatus 11) to which is mounted the removable recording medium 25 in which the output RAW image data DT11-1 to the output RAW image data DT11-5 have been recorded, output JPEG image data DT21-1 to output JPEG image data DT21-5 are generated.

Each of the output JPEG image data DT21-1 to the output JPEG image data DT21-5 is generated on the basis of each of the output RAW image data DT11-1 to the output RAW image data DT11-5.

The generation of the output JPEG image data DT21-1 to the output JPEG image data DT21-5 may be performed by another information processing apparatus such as a personal computer (PC) to which the removable recording medium 25 has been mounted.

For example, the output JPEG image data DT21-1 includes the metadata MT11-1 included in the output RAW image data DT11-1 from which the output JPEG image data DT21-1 was generated, a JPEG image generated by development processing from the RAW image G11-1, and ID information “X”.

In this case, the ID information “X” stored in the output JPEG image data DT21-1 is, for example, a medium ID “X” of the removable recording medium 25 or a user ID “X” of an account of the user acquired due to the photographing apparatus 11 connecting to any online service or the like.

In addition, the metadata MT11-1 included in the output JPEG image data DT21-1 includes the reduced image of the RAW image G11-1 and the ID information “A” as described above. Therefore, the output JPEG image data DT21-1 is to include a plurality of different types of ID information: the ID information “A”and the ID information “X”.

Since temporally-preceding output JPEG image data does not exist with respect to the output JPEG image data DT21-1, the output JPEG image data DT21-1 does not include a hash value of temporally-preceding output JPEG image data.

The output JPEG image data DT21-2 is output data that temporally follows (next to) the output JPEG image data DT21-1.

The output JPEG image data DT21-2 includes the metadata MT11-2 included in the output RAW image data DT11-2, a JPEG image generated by development processing from the RAW image G11-2, the ID information “X”, and a hash value of the temporally-preceding output JPEG image data DT21-1.

In this case, the hash value of the temporally preceding output JPEG image data DT21-1 is a hash value having been calculated by an operation of a hash function with the entire output JPEG image data DT21-1 as an object. Instead of the hash value, a signature generated on the basis of the hash value of the output JPEG image data DT21-1 and a private key of the photographing apparatus 11 may be stored in the output JPEG image data DT21-2.

Furthermore, the output JPEG image data DT21-3 to the output JPEG image data DT21-5 following the output JPEG image data DT21-2 are also generated in a similar manner to the output JPEG image data DT21-2.

In particular, the output JPEG image data DT21-1 to the output JPEG image data DT21-5 that are generated in a time series (sequentially) in the photographing apparatus 11 include the same ID information “X”.

For example, in this example, the output RAW image data DT11-3 and the output RAW image data DT11-4 are not temporally consecutive pieces of output data.

However, since the output JPEG image data DT21-3 generated from the output RAW image data DT11-3 and the output JPEG image data DT21-4 generated from the output RAW image data DT11-4 are generated in order by the same photographing apparatus 11, the output JPEG image data DT21-3 and the output JPEG image data DT21-4 are temporally consecutive pieces of output data.

Therefore, the output JPEG image data DT21-4 includes the metadata MT11-3 included in the output RAW image data DT11-4, a JPEG image generated by development processing from the RAW image G11-3, the ID information “X”, and a hash value of the temporally-preceding output JPEG image data DT21-3.

In addition, image data (hereinafter, also referred to as edited image data) obtained by editing any of the output JPEG image data DT21-1 to the output JPEG image data DT21-5 or the like can be published on the Web by any information processing apparatus such as a PC.

In this example, edited image data DT31-1 generated from the output JPEG image data DT21-1 and edited image data DT31-2 generated from the output JPEG image data DT21-5 are published on the Web.

For example, the edited image data DT31-1 and the edited image data DT31-2 are data in a format compliant with C2PA that includes metadata in the JUMBF (JPEG Universal Metadata Box Format) format called a C2PA Manifest (hereinafter simply referred to as a manifest).

Specifically, for example, the edited image data DT31-2 stores a manifest, XMP (Extensible Metadata Platform) metadata, and the like in addition to the output JPEG image data DT21-5.

In this case, for example, the manifest of the edited image data DT31-2 includes a Claim generated from information related to the output JPEG image data DT21-5 from which the edited image data DT31-2 was generated and a signature of the Claim (Claim Signature).

In this case, the Claim can be, for example, information that is included in the output JPEG image data DT21-5 and generated on the basis of the hash value of the temporally preceding output JPEG image data DT21-4 or, in other words, information including a hash value.

Such a Claim and a signature (Claim Signature) are information for verifying the authenticity of the output JPEG image data DT21-5 or, in other words, a JPEG image and metadata.

The manifest of the edited image data DT31-2 may also include a Claim generated from information related to the output RAW image data DT11-5 from which the output JPEG image data DT21-5 was generated and a signature of the Claim (Claim Signature).

In this case, the Claim related to the output RAW image data DT11-5 can be generated on the basis of, for example, a part of or all of the metadata MT11-4 such as the hash value of the metadata MT11-3 that is included in the metadata MT11-4.

Storing a Claim related to the output JPEG image data DT21-5 or a Claim related to the output RAW image data DT11-5 in the manifest of the edited image data DT31-2 enables a relationship and the like of the output JPEG image data DT21-5 (JPEG image) and the output RAW image data DT11-5 (RAW image G11-4) to be verified.

In the example described above, a contextual relationship between consecutive pieces of image data such as the output RAW image data DT11-1 and the output RAW image data DT11-2, the output JPEG image data DT21-4 and the output JPEG image data DT21-5, and the output JPEG image data DT21-4 and the edited image data DT31-2 can be proven (verified).

For example, since the edited image data DT31-2 includes the output JPEG image data DT21-5 from which the edited image data DT31-2 was generated, the contextual relationship between the edited image data DT31-2 and the output JPEG image data DT21-4 can be verified.

### Description of Photography Processing

Next, an operation of the photographing apparatus 11 will be described.

Since operations of the photographing apparatus 11 and the smartphone 51 are basically similar to each other, only the operation of the photographing apparatus 11 will now be described.

For example, when the input unit 23 is operated by the user and an instruction to start photography is issued, the photographing apparatus 11 starts photography processing according to a signal supplied from the input unit 23 due to the operation by the user.

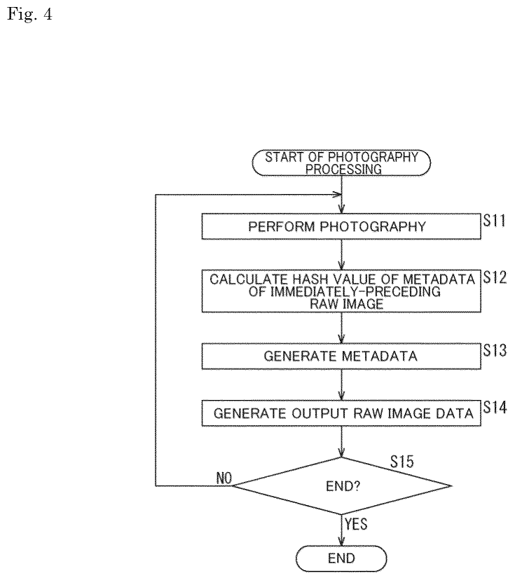

Hereinafter, photography processing by the photographing apparatus 11 will be described with reference to the flow chart shown in FIG. 4.

In step S11, the image sensor 21 performs photography by photoelectrically converting light incident from outside and supplies (outputs) a resulting RAW image to the image processor 22. In other words, the image processor 22 acquires the RAW image from the image sensor 21 in a stage preceding the image processor 22.

In this case, the image sensor 21 and the image processor 22 perform mutual authentication to construct an authenticated communication channel and exchange various types of data such as RAW images using the communication channel. Accordingly, an occurrence of falsification of a RAW image and the like on the communication channel can be suppressed.

For example, the image sensor 21 encrypts the RAW image and supplies a resulting encrypted RAW image or, in other words, the RAW image having been encrypted to the image processor 22 via the authenticated communication channel constructed between the image sensor 21 and the image processor 22. As a result, the image processor 22 decrypts the encrypted RAW image supplied from the image sensor 21 and obtains the RAW image.

Otherwise, encryption of a sensor ID may be performed even when, for example, the sensor ID is supplied from the image sensor 21 to the image processor 22.

In step S12, when there is a RAW image that temporally immediately precedes the RAW image (hereinafter, also referred to as a processing object RAW image) supplied from the image sensor 21, the image processor 22 calculates a hash value of metadata of the immediately preceding RAW image.

As described above, a calculation object of the hash value need not be metadata and may be all of output RAW image data constituted of the metadata and a RAW image or only a part of the metadata.

In Step S13, the Image Processor 22 Generates Metadata of the Processing object RAW image.

For example, based on the processing object RAW image, the image processor 22 generates a reduced image of the RAW image. In addition, the image processor 22 either reads an ISP ID held by itself as ID information or acquires a sensor ID from the image sensor 21 as ID information.

In addition, the image processor 22 generates data including the hash value obtained in step S12 and the ID information and the reduced image obtained with respect to the processing object RAW image as metadata of the processing object RAW image.

The metadata may store a signature of a hash value instead of the hash value. In such a case, the image processor 22 generates the signature based on the hash value obtained in step S12 and the private key of the photographing apparatus 11 held in advance (prepared in advance).

In addition, the metadata may store a plurality of pieces of ID information of mutually-different types such as a sensor ID and an ISP ID. That way, even when troubleshooting such as replacing the image sensor 21 or the like is performed, a temporal contextual relationship of output RAW image data can be proved.

In step S14, the image processor 22 generates output RAW image data including a processing object RAW image and metadata of the processing object RAW image and supplies (outputs) the output RAW image data to the control unit 26. In other words, data (file) including a RAW image and metadata is generated as the output RAW image data.

When appropriate, the control unit 26 holds the output RAW image data supplied from the image processor 22 or supplies the output RAW image data to the removable recording medium 25 to be recorded.

In step S15, the control unit 26 determines whether or not to end photography of a RAW image.

When it is determined in step S15 that photography should not be ended, processing returns to step S11 and the processing described above is repeatedly performed.

Conversely, when it is determined in step S15 that photography should be ended, the control unit 26 controls the image sensor 21 and the image processor 22 to stop photography of a RAW image and stop generation of output RAW image data, and photography processing is ended.

As described above, when generating temporally consecutive output RAW image data, the photographing apparatus 11 stores, in metadata of a RAW image, a hash value of metadata of a temporally immediately preceding RAW image of the RAW image.

Accordingly, even when output RAW image data is generated in an offline environment, a contextual relationship of consecutive pieces of output RAW image data (RAW images) can be proved. Moreover, by having the image processor 22 immediately following the image sensor 21 generate output RAW image data, the output RAW image data can be shown to be closer to the original.

### Description of Image Data Generation Processing

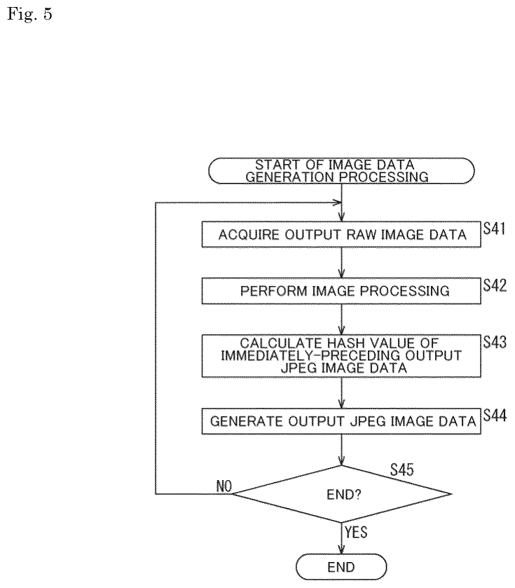

When the photography processing described with reference to FIG. 4 is performed by the photographing apparatus 11, subsequently, the photographing apparatus 11 performs image data generation processing shown in FIG. 5 at any timing.

Hereinafter, image data generation processing by the photographing apparatus 11 will be described with reference to the flow chart shown in FIG. 5.

In step S41, the control unit 26 acquires output RAW image data to be a processing object among a plurality of pieces of temporally consecutive output RAW image data.

For example, the control unit 26 may acquire output RAW image data sequentially supplied from the image processor 22 by the photography processing shown in FIG. 4 or acquire output RAW image data recorded in the removable recording medium 25 in an order of a time series from the removable recording medium 25.

In step S42, the control unit 26 performs any image processing including development processing with respect to the RAW image included in the output RAW image data acquired in step S41 and generates a JPEG image. For example, editing processing such as brightness adjustment by the user may be performed as the image processing.

In step S43, when there is a JPEG image that temporally immediately precedes the JPEG image (hereinafter, also referred to as a processing object JPEG image) generated in step S42, the control unit 26 calculates a hash value of the output JPEG image data including the immediately preceding JPEG image.

In this case, the hash value may be calculated with an entirety of the immediately preceding output JPEG image data as an object or the hash value may be calculated with a part of the immediately preceding output JPEG image data as an object.

In step S44, the control unit 26 generates output JPEG image data corresponding to the output RAW image data acquired in step S41.

For example, with respect to the processing object JPEG image, the control unit 26 acquires a medium ID indicating the removable recording medium 25 from the removable recording medium 25 as ID information.

When a user ID such as a user ID for an online account of the user or the like can be acquired due to the photographing apparatus 11 including a function of communicating with an external apparatus or the like, the user ID may be acquired as ID information. In addition, a plurality of different types of ID information such as a medium ID and a user ID may be acquired.

The control unit 26 generates output JPEG image data including the ID information acquired in this manner, the metadata included in the output RAW image data acquired in step S41, the processing object JPEG image acquired in step S42, and the hash value acquired in step S43.

In other words, data (file) including metadata of a RAW image, a JPEG image, ID information, and a hash value is generated as the output JPEG image data.

The output JPEG image data may store a signature of the hash value instead of the hash value. In such a case, the control unit 26 generates the signature based on the hash value obtained in step S43 and the private key of the photographing apparatus 11 held in advance.

When the control unit 26 generates the output JPEG image data in this manner, the control unit 26 supplies the generated output JPEG image data to the removable recording medium 25 to be recorded or outputs the generated output JPEG image data to an external apparatus via the input/output unit 27.

In step S45, the control unit 26 determines whether or not to end generation of output JPEG image data.

When it is determined in step S45 that generation of output JPEG image data should not be ended, processing returns to step S41 and the processing described above is repeatedly performed.

Conversely, when it is determined in step S45 that generation of output JPEG image data should be ended, the control unit 26 stops processing for generating output JPEG image data and the image data generation processing is ended.

As described above, when generating temporally consecutive output JPEG image data, the photographing apparatus 11 stores, in each output JPEG image data, a hash value of a temporally immediately preceding output JPEG image data of the output JPEG image data.

Accordingly, even when output JPEG image data is generated in an offline environment, a contextual relationship of consecutive pieces of output JPEG image data (JPEG images) can be proved.

In particular, since output JPEG image data stores a plurality of mutually-different types of ID information, by verifying that one or more types of ID information among the plurality of types of ID information match, a contextual relationship of output JPEG image data can be proved even when troubleshooting or the like is carried out.

### Configuration Example of Information Processing Device

A contextual relationship of temporally consecutive pieces of output RAW image data (RAW images) or output JPEG image data (JPEG images) can be verified (proved) in any information processing apparatus such as a PC or a server.

For example, in the example shown in FIG. 3, a contextual relationship between the edited image data DT31-2 published on the Web and the output JPEG image data DT21-4 held by the photographer can be proved.

In addition, contextual relationships between consecutive pieces of image data such as the contextual relationship between the output RAW image data DT11-2 and the output RAW image data DT11-3 and the contextual relationship between the output JPEG image data DT21-3 and the output JPEG image data DT21-4 can be proved.

Hereinafter, a case of verifying a contextual relationship between two pieces of temporally consecutive output JPEG image data will be described as a specific example.

In particular, it is assumed that one output JPEG image data of the two pieces of output JPEG image data is a verification object of contextual relationship and the other output JPEG image data is published on the Web.

Hereinafter, the output JPEG image data that is a verification object will also be referred to as verification object image data and the published output JPEG image data used for verification will also be referred to as published image data.

In addition, a JPEG image included in the output JPEG image data to be the verification object image data will also be referred to as a verification object image and a JPEG image included in the output JPEG image data to be the published image data will also be referred to as a published image.

In this example, by proving (verifying) a temporal contextual relationship between the verification object image and the published image, it is possible to prove a provenance of the verification object image and that the verification object image has not been tampered with as a result.

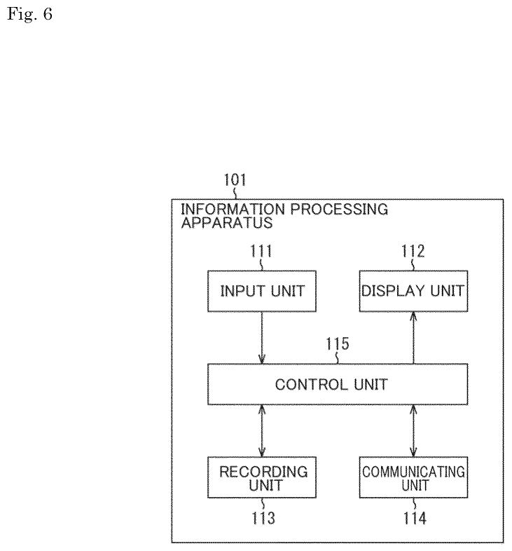

For example, the information processing apparatus for verifying the contextual relationship between the verification object image data (verification object image) and the published image data (published image) is configured as shown in FIG. 6.

An information processing apparatus 101 shown in FIG. 6 is any information processing apparatus such as a personal computer (PC).

The information processing apparatus 101 includes an input unit 111, a display unit 112, a recording unit 113, a communicating unit 114, and a control unit 115.

The input unit 111 is constituted of a mouse and a keyboard or the like and supplies the control unit 115 with a signal in accordance with an operation by a user. The display unit 112 is constituted of a display or the like and displays various types of images in accordance with control by the control unit 115.

The recording unit 113 is constituted of, for example, a memory and records various types of data such as an image supplied from the control unit 115, and supplies the control unit 115 with recorded data when necessary.

The communicating unit 114 communicates with an external apparatus. For example, the communicating unit 114 transmits data supplied from the control unit 115 to the external apparatus and receives any data such as published image data transmitted from the external apparatus and supplies the received data to the control unit 115.

The control unit 115 controls an operation of the entire information processing apparatus 101. For example, in accordance with a signal from the input unit 111, the control unit 115 performs verification of a contextual relationship between published image data supplied from the communicating unit 114 and verification object image data recorded in the recording unit 113.

### Description of Verification Processing

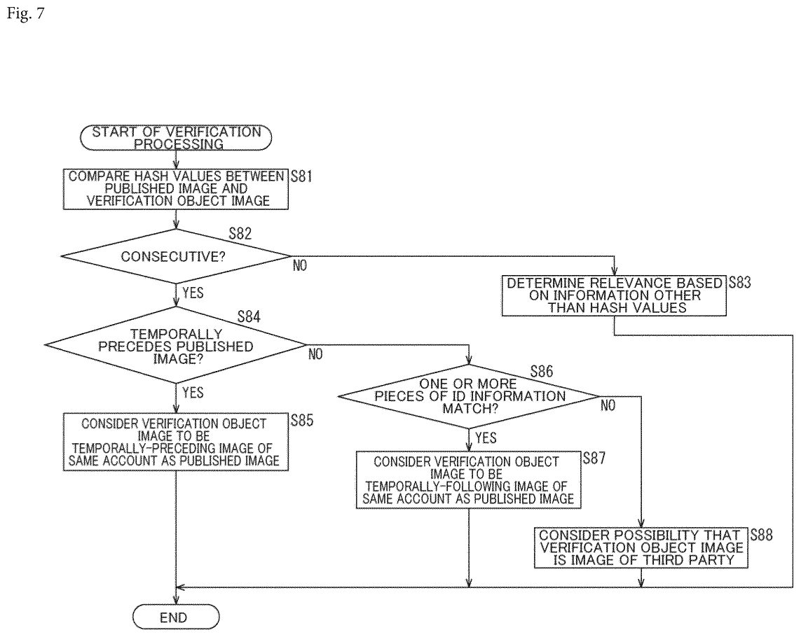

Next, verification processing to be performed by the information processing apparatus 101 will be described with reference to the flow chart shown in FIG. 7.

Prior to the start of the verification processing, the published image data has been acquired by the information processing apparatus 101 in advance from an external apparatus such as a server on the Web and the verification object image data has also been stored in the information processing apparatus 101.

Once the verification processing starts, in step S81, the control unit 115 compares hash values between the published image (published image data) and the verification object image (verification object image data).

In other words, the control unit 115 compares a hash value calculated on the basis of a part or all of one of the published image data and the verification object image data and a hash value included in the other of the published image data and the verification object image data and determines whether the hash values match.

Specifically, for example, the control unit 115 calculates the hash value of the published image data based on the published image data and compares the obtained hash value with a hash value of output JPEG image data temporally immediately preceding the verification object image data that is included in the verification object image data.

In this case, if the hash value of the published image data and the hash value included in the verification object image data match each other, it means that the published image and the verification object image have been specified as being temporally consecutive. In other words, it means that a contextual relationship between the published image and the verification object image has been specified. Particularly, in this case, it means that the verification object image has been specified to be an image temporally immediately following the published image.

In addition, if the hash value of the published image data and the hash value included in the verification object image data do not match each other, the control unit 115 calculates the hash value of the verification object image data based on the verification object image data.

Furthermore, the control unit 115 compares the obtained hash value with a hash value of output JPEG image data temporally immediately preceding the published image data that is included in the published image data. At this point, if the hash values match, it means that the verification object image has been specified to be an image temporally immediately preceding the published image.

A signature instead of a hash value may be stored in published image data or verification object image data as output JPEG image data.

In such a case, the control unit 115 obtains a hash value based on a signature stored in one of the output JPEG image data (the published image data or the verification object image data) and a public key that has been published in advance of a device having generated the output JPEG image data such as the photographing apparatus 11. In other words, the control unit 115 obtains a hash value by decrypting the signature based on the public key.

The control unit 115 compares the hash value obtained from the signature and the hash value calculated on the basis of the other output JPEG image data (the verification object image data or the published image data).

When comparing the hash values with respect to the published image data and the verification object image data as output JPEG image data, hash values of metadata of RAW images may be compared instead of the hash values of output JPEG image data.

In such a case, a hash value of metadata of a RAW image included in the one output JPEG image data is calculated on the basis of the metadata and the calculated hash value and a hash value included in metadata of a RAW image included in the other output JPEG image data are compared with each other.

In step S82, based on a result of the comparison between hash values in step S81, the control unit 115 determines whether or not the verification object image and the published image are temporally consecutive. For example, in step S82, a determination that the images are temporally consecutive is made when the hash values match.

When it is determined in step S82 that the images are not temporally consecutive, in step S83, the control unit 115 determines a relevance of the verification object image and the published image based on information other than hash values.

For example, when it is determined in step S82 that the images are not temporally consecutive, it means that the contextual relationship (relevance) of the verification object image and the published image could not be specified by the comparison of hash values performed in step S81. In other words, it means that the verification (proof) of the contextual relationship of the verification object image and the published image has failed.

Therefore, the control unit 115 performs processing of specifying (determining) a relationship between the verification object image and the published image using information other than hash values such as comparing ID information respectively included in the verification object image data and the published image data.

In this case, for example, if user IDs as ID information match between the verification object image and the published image, although a contextual relationship between the verification object image and the published image cannot be proved, at the very least, a relevance that the verification object image and the published image may possibly have been generated by the same user can be specified.

The control unit 115 controls the display unit 112 when necessary and causes the display unit 112 to display a determination result of the relevance between the verification object image and the published image.

Once the determination of the relevance between the verification object image and the published image is performed, the verification processing ends.

In addition, when the verification object image and the published image are determined to be temporally consecutive in step S82, the control unit 115 performs the processing of step S84.

Specifically, in step S84, based on a result of the comparison between hash values in step S81, the control unit 115 determines whether or not the verification object image is an image that temporally precedes the published image.

When it is determined in step S84 that the verification object image is a temporally preceding image, the processing advances to step S85.

In step S85, the control unit 115 considers the verification object image to be an image having been generated by a user with the same account as the published image (the same user) and that temporally precedes (immediately precedes) the published image. In other words, it is assumed that a verification result that the verification object image is an image temporally immediately preceding the published image has been obtained.

In this case, since the verification object image is an image temporally preceding the published image that has been published, it can be assumed that a contextual relationship has been proved without having to compare ID information. In particular, in this case, the contextual relationship is proved regardless of whether troubleshooting or the like of equipment is performed.

Once the contextual relationship of the verification object image (verification object image data) is verified, the control unit 115 causes the display unit 112 to display a verification result thereof when necessary and the verification processing ends.

Alternatively, when it is determined in step S84 that the verification object image is not a temporally preceding image or, in other words, the verification object image is an image that temporally follows the published image, the processing subsequently advances to step S86.

In step S86, the control unit 115 compares a plurality of pieces of ID information such as a sensor ID and a medium ID included in the verification object image data with a plurality of pieces of ID information included in the published image data and determines whether or not one or more pieces of the ID information match.

When it is determined in step S86 that one or more pieces of the ID information match, in step S87, the control unit 115 considers the verification object image to be an image having been generated by a user with the same account as the published image (the same user) and that temporally follows (immediately follows) the published image. In other words, it is assumed that a verification result that the verification object image is an image temporally immediately following the published image has been obtained.

In this case, since the verification object image is an image that temporally follows the published image that has been published, there is a possibility that a malicious third party with knowledge of an image data generation algorithm has tampered with the image data by storing a hash value of the published image data in the verification object image data or the like.

In consideration thereof, the control unit 115 more reliably verifies that the verification object image is an image immediately following the published image by also verifying whether one or more pieces of ID information match between the verification object image data and the published image data.

Particularly, in this case, since the verification object image data and the published image data each store a plurality of pieces of ID information that mutually differ, a contextual relationship between the verification object image and the published image can be proved even when troubleshooting of equipment or the like is carried out.

For example, let us assume that, as a result of the comparison of ID information in step S86, sensor IDs as ID information did not match but medium IDs and user IDs as ID information matched.

In such a case, a verification result can be obtained in that although the verification object image and the published image are temporally preceding and following images generated by the same user, the images were taken before and after troubleshooting such as equipment replacement was performed.

In step S87, in order to more reliably prove the contextual relationship between the verification object image and the published image, the contextual relationship may be re-verified at any timing such as when the verification object image is newly published by comparing hash values in the metadata or by any other method.

Once the contextual relationship of the verification object image is verified, the control unit 115 causes the display unit 112 to display a verification result thereof when necessary and the verification processing ends.

In addition, when it is determined in step S86 that none of the ID information match, in step S88, the control unit 115 considers the verification object image to possibly be an image of a third party that differs from the user having generated the published image.

In this case, since the contextual relationship based on hash values has been specified despite ID information not matching, in order to obtain a more reliable verification result, the contextual relationship may be re-verified by any other method at any timing such as when the verification object image is newly published.

Once the contextual relationship of verification object image is verified, the control unit 115 causes the display unit 112 to display a verification result thereof when necessary and the verification processing ends.

As described above, the information processing apparatus 101 performs verification of the contextual relationship between the verification object image and the published image by comparing hash values or ID information.

In particular, in the information processing apparatus 101, by performing a comparison of not only hash values but also a plurality of types of ID information, a contextual relationship of the verification object image can be proved (verified) even when troubleshooting or the like has been performed. In other words, it is possible to prove a provenance of the verification object image and that the verification object image has not been tampered with.

### Configuration Example of Computer

The series of processing described above can be executed by hardware or by software. When the series of processing is to be executed by software, a program constituting the software is installed in a computer. Examples of the computer in this case include a computer built into dedicated hardware and a general-purpose personal computer or the like capable of executing various functions when various programs are installed therein.

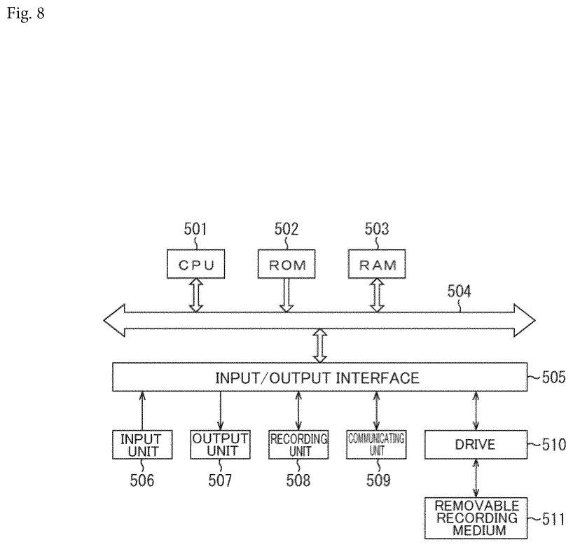

FIG. 8 is a block diagram showing a configuration example of hardware of a computer that executes the series of processing described above with a program.

In the computer, a CPU (Central Processing Unit) 501, a ROM (Read Only Memory) 502, and a RAM (Random Access Memory) 503 are connected to each other by a bus 504.

An input/output interface 505 is further connected to the bus 504. An input unit 506, an output unit 507, a recording unit 508, a communication unit 509, and a drive 510 are connected to the input/output interface 505.

For example, the input unit 506 is constituted of a keyboard, a mouse, a microphone, an image sensor, or the like. The output unit 507 is constituted by a display, a speaker, or the like. The recording unit 508 is constituted by a hard disk, a non-volatile memory, or the like. The communication unit 509 is constituted by a network interface or the like. The drive 510 drives a removable recording medium 511 that is a magnetic disk, an optical disk, a magneto optical disk, a semiconductor memory, or the like.

In the computer configured as described above, the series of processing described above is performed as the CPU 501 loads a program recorded in the recording unit 508 onto the RAM 503 via the input/output interface 505 and the bus 504 and executes the program.

For example, the program executed by the computer (the CPU 501) can be provided by being recorded on the removable recording medium 511 as a packaged medium or the like. Alternatively, the program can be provided via a wired or wireless transmission medium such as a local area network, the Internet, or digital satellite broadcasting.

In the computer, the program can be installed in the recording unit 508 via the input/output interface 505 by mounting the removable recording medium 511 to the drive 510. In addition, the program can be received by the communication unit 509 via a wired or wireless transmission medium and installed in the recording unit 508. Alternatively, the program can be installed in the ROM 502 or the recording unit 508 in advance.

The program to be executed by the computer may be a program which causes processing to be time-sequentially performed along an order described in the present specification or a program which causes processing to be performed in parallel or at necessary timings such as when a call is made.

In addition, embodiments of the present technique are not limited to the embodiment described above and various modifications can be made without departing from the gist of the present technique.

For example, the present technique may adopt a configuration of cloud computing in which a single function is shared among and cooperatively processed by a plurality of apparatuses via a network.

In addition, each step explained in the flow charts described above can be executed in a shared manner by a plurality of apparatuses in addition to being executed by a single apparatus.

Furthermore, when a single step includes a plurality of processing steps, the plurality of processing steps included in the single step can be executed in a shared manner by a plurality of apparatuses in addition to being executed by a single apparatus.

Moreover, the present technique can also be configured as follows.
(1)

An information processing apparatus that generates output data including object data to be a verification object of a temporal contextual relationship, the information processing apparatus including:
a control unit configured to generate the output data including a hash value calculated on the basis of a part of or all of output data that temporally immediately-precedes the output data, the object data, and a plurality of mutually-different types of ID information related to the object data.
(2)

The information processing apparatus according to (1), wherein the control unit is configured to calculate the hash value based on data including at least the ID information in the temporally immediately-preceding output data.
(3)

The information processing apparatus according to (1) or (2), wherein the object data is an image.
(4)

The information processing apparatus according to (3), wherein the image is a RAW image, an image obtained by development processing, an image obtained by editing processing, or a simulator output image.
(5)

The information processing apparatus according to (1) or (2), wherein the object data is a RAW image, and
the control unit is configured to generate the output data including the RAW image output from an image sensor in a stage preceding the control unit itself.
(6)

The information processing apparatus according to (5), wherein the control unit is configured to acquire the RAW image having been encrypted from the image sensor via an authenticated communication channel constructed between the control unit and the image sensor.
(7)

The information processing apparatus according to (5) or (6), wherein the output data includes metadata including a reduced image of the RAW image, the ID information, and the hash value and the RAW image, and the control unit is configured to calculate the hash value based on the metadata included in the temporally immediately-preceding output data.
(8)

The information processing apparatus according to any one of (1) to (7), wherein
the control unit is configured to generate a signature based on the hash value and a key prepared in advance and to generate the output data including the signature, the object data, and the plurality of pieces of ID information.
(9)

The information processing apparatus according to any one of (1) to (8), wherein
the ID information is a sensor ID, a processor ID, a medium ID, or a user ID.
(10)

An information processing method of an information processing apparatus that generates output data including object data to be a verification object of a temporal contextual relationship, the information processing method including the step of:
generating the output data including a hash value calculated on the basis of a part of or all of output data that temporally immediately-precedes the output data, the object data, and a plurality of mutually-different types of ID information related to the object data.
(11)

A program causing a computer that controls an information processing apparatus that generates output data including object data to be a verification object of a temporal contextual relationship to execute processing including the step of:
generating the output data including a hash value calculated on the basis of a part of or all of output data that temporally immediately-precedes the output data, the object data, and a plurality of mutually-different types of ID information related to the object data.
(12)

An information processing apparatus that verifies a temporal contextual relationship between object data included in output data and another object data included in another output data,
the output data including a hash value calculated on the basis of a part of or all of output data that temporally immediately-precedes the output data, the object data, and a plurality of mutually-different types of ID information related to the object data, the information processing apparatus including:
a control unit configured to verify a temporal contextual relationship between the object data and the other object data by comparing the hash value calculated on the basis of a part of or all of one of the output data and the other output data and the hash value included in the other of the output data and the other output data and by comparing the pluralities of types of ID information respectively included in the output data and the other output data.
(13)

The information processing apparatus according to (12), wherein the control unit is configured to consider that the object data is data temporally immediately-following the other object data when the hash value calculated on the basis of a part of or all of the other output data and the hash value included in the output data match and, as a result of a comparison between the plurality of pieces of ID information included in the output data and the plurality of pieces of ID information included in the other output data, one or more pieces of the ID information match.
(14)

The information processing apparatus according to (12) or (13), wherein the control unit is configured to consider that the object data is data temporally immediately-preceding the other object data when the hash value calculated on the basis of a part of or all of the output data and the hash value included in the other output data match.
(15)

The information processing apparatus according to any one of (12) to (14), wherein
the hash value is calculated on the basis of data including at least the ID information in the temporally immediately-preceding output data.
(16)

The information processing apparatus according to any one of (12) to (15), wherein
the object data is an image.
(17)

The information processing apparatus according to (16), wherein the image is a RAW image, an image obtained by development processing, an image obtained by editing processing, or a simulator output image.
(18)

The information processing apparatus according to any one of (12) to (16), wherein
the ID information is a sensor ID, a processor ID, a medium ID, or a user ID.
(19)

An information processing method of an information processing apparatus that verifies a temporal contextual relationship between object data included in output data and another object data included in another output data,
the output data including a hash value calculated on the basis of a part of or all of output data that temporally immediately-precedes the output data, the object data, and a plurality of mutually-different types of ID information related to the object data, the information processing method including the step of:
verifying a temporal contextual relationship between the object data and the other object data by comparing the hash value calculated on the basis of a part of or all of one of the output data and the other output data and the hash value included in the other of the output data and the other output data and by comparing the pluralities of types of ID information respectively included in the output data and the other output data.
(20)

A program causing a computer that controls an information processing apparatus that verifies a temporal contextual relationship between object data included in output data and another object data included in another output data to execute processing including the step of:
verifying a temporal contextual relationship between the object data and the other object data by comparing a hash value calculated on the basis of a part of or all of one of the output data and the other output data and a hash value included in the other of the output data and the other output data and by comparing pluralities of types of ID information respectively included in the output data and the other output data, wherein
the output data includes a hash value calculated on the basis of a part of or all of output data that temporally immediately-precedes the output data, the object data, and a plurality of mutually-different types of ID information related to the object data.

### Reference Signs List

11 Photographing apparatus
21 Image sensor
22 Image processor
25 Removable recording medium
26 Control unit
51 Smartphone
63 Recording unit
66 Communicating unit
67 Control unit
101 Information processing apparatus
115 Control unit

1. An information processing apparatus that generates output data including object data to be a verification object of a temporal contextual relationship, the information processing apparatus comprising:
a control unit configured to generate the output data including a hash value calculated on the basis of a part of or all of output data that temporally immediately-precedes the output data, the object data, and a plurality of mutually-different types of ID information related to the object data.

2. The information processing apparatus according to claim 1, wherein the control unit is configured to calculate the hash value based on data including at least the ID information in the temporally immediately-preceding output data.

3. The information processing apparatus according to claim 1, wherein the object data is an image.

4. The information processing apparatus according to claim 3, wherein the image is a RAW image, an image obtained by development processing, an image obtained by editing processing, or a simulator output image.

5. The information processing apparatus according to claim 1, wherein the object data is a RAW image, and
the control unit is configured to generate the output data including the RAW image output from an image sensor in a stage preceding the control unit itself.

6. The information processing apparatus according to claim 5, wherein the control unit is configured to acquire the RAW image having been encrypted from the image sensor via an authenticated communication channel constructed between the control unit and the image sensor.

7. The information processing apparatus according to claim 5, wherein the output data includes metadata including a reduced image of the RAW image, the ID information, and the hash value and the RAW image, and the control unit is configured to calculate the hash value based on the metadata included in the temporally immediately-preceding output data.

8. The information processing apparatus according to claim 1, wherein the control unit is configured to generate a signature based on the hash value and a key prepared in advance and to generate the output data including the signature, the object data, and the plurality of pieces of ID information.

9. The information processing apparatus according to claim 1, wherein the ID information is a sensor ID, a processor ID, a medium ID, or a user ID.

10. An information processing method of an information processing apparatus that generates output data including object data to be a verification object of a temporal contextual relationship, the information processing method comprising the step of:
generating the output data including a hash value calculated on the basis of a part of or all of output data that temporally immediately-precedes the output data, the object data, and a plurality of mutually-different types of ID information related to the object data.

11. A program causing a computer that controls an information processing apparatus that generates output data including object data to be a verification object of a temporal contextual relationship to execute processing including the step of:
generating the output data including a hash value calculated on the basis of a part of or all of output data that temporally immediately-precedes the output data, the object data, and a plurality of mutually-different types of ID information related to the object data.

12. An information processing apparatus that verifies a temporal contextual relationship between object data included in output data and another object data included in another output data,
the output data including a hash value calculated on the basis of a part of or all of output data that temporally immediately-precedes the output data, the object data, and a plurality of mutually-different types of ID information related to the object data, the information processing apparatus comprising:
a control unit configured to verify a temporal contextual relationship between the object data and the other object data by comparing the hash value calculated on the basis of a part of or all of one of the output data and the other output data and the hash value included in the other of the output data and the other output data and by comparing the pluralities of types of ID information respectively included in the output data and the other output data.

13. The information processing apparatus according to claim 12, wherein the control unit is configured to consider that the object data is data temporally immediately-following the other object data when the hash value calculated on the basis of a part of or all of the other output data and the hash value included in the output data match and, as a result of a comparison between the plurality of pieces of ID information included in the output data and the plurality of pieces of ID information included in the other output data, one or more pieces of the ID information match.

14. The information processing apparatus according to claim 12, wherein the control unit is configured to consider that the object data is data temporally immediately-preceding the other object data when the hash value calculated on the basis of a part of or all of the output data and the hash value included in the other output data match.

15. The information processing apparatus according to claim 12, wherein the hash value is calculated on the basis of data including at least the ID information in the temporally immediately-preceding output data.

16. The information processing apparatus according to claim 12, wherein the object data is an image.

17. The information processing apparatus according to claim 16, wherein the image is a RAW image, an image obtained by development processing, an image obtained by editing processing, or a simulator output image.

18. The information processing apparatus according to claim 12, wherein the ID information is a sensor ID, a processor ID, a medium ID, or a user ID.

19. An information processing method of an information processing apparatus that verifies a temporal contextual relationship between object data included in output data and another object data included in another output data,
the output data including a hash value calculated on the basis of a part of or all of output data that temporally immediately-precedes the output data, the object data, and a plurality of mutually-different types of ID information related to the object data, the information processing method comprising the step of:
verifying a temporal contextual relationship between the object data and the other object data by comparing the hash value calculated on the basis of a part of or all of one of the output data and the other output data and the hash value included in the other of the output data and the other output data and by comparing the pluralities of types of ID information respectively included in the output data and the other output data.

20. A program causing a computer that controls an information processing apparatus that verifies a temporal contextual relationship between object data included in output data and another object data included in another output data to execute processing including the step of:
verifying a temporal contextual relationship between the object data and the other object data by comparing a hash value calculated on the basis of a part of or all of one of the output data and the other output data and a hash value included in the other of the output data and the other output data and by comparing pluralities of types of ID information respectively included in the output data and the other output data, wherein
the output data includes a hash value calculated on the basis of a part of or all of output data that temporally immediately-precedes the output data, the object data, and a plurality of mutually-different types of ID information related to the object data.
